(19) United States
(12) Patent Application Publication
(10) Pub. No.: US 2026/0149086 A1
(43) Pub. Date: May 28, 2026

(54) MANUFACTURING APPARATUS FOR BATTERY CELL AND MANUFACTURING METHOD FOR BATTERY CELL

(71) Applicant: SK On Co., Ltd., Seoul (KR)

(72) Inventors: Kwae Ha KIM, Daejeon (KR); Dae Jin LEE, Daejeon (KR); Joo Eun LEE, Daejeon (KR); Kyung Hee JEONG, Daejeon (KR)

(21) Appl. No.: 19/398,044

(22) Filed: Nov. 24, 2025

(30) Foreign Application Priority Data
Nov. 22, 2024 (KR) 10-2024-0168543

(51) Int. Cl. H01M 10/657; H01M 10/04; H01M 10/48; H01M 10/615; H01M 10/63; H01M 10/658; H01M 50/183

(52) U.S. Cl. CPC H01M 10/657; H01M 10/0481; H01M 10/48; H01M 10/615; H01M 10/63; H01M 10/658; H01M 50/183

(57) ABSTRACT

The present disclosure relates to a manufacturing apparatus for manufacturing a battery cell comprising an electrode assembly and an exterior material accommodating the electrode assembly, the battery cell manufacturing apparatus comprising: a first heating unit heating a sealing portion formed along an outside of an accommodating portion accommodating the electrode assembly such that a temperature of the sealing portion becomes a preset first temperature; a second heating unit heating the sealing portion such that the temperature of the sealing portion becomes a preset second temperature; and a control unit controlling the first heating unit and the second heating unit based on a temperature of the exterior material.

### CROSS-REFERENCE TO RELATED PATENT APPLICATION

The present application claims priority under 35 U.S.C. § 119(a) to Korean patent application number 10-2024-0168543 filed on Nov. 22, 2024, in the Korean Intellectual Property Office, the entire disclosure of which is incorporated by reference herein.

### BACKGROUND OF THE INVENTION

### 1. Field

Embodiments of the present disclosure relate to a battery cell manufacturing apparatus and a battery cell manufacturing method.

### 2. Description of the Related Art

A secondary battery is a battery that stores electrical energy by converting it into chemical energy and enables repeated reuse through charging and discharging. Due to its economical and eco-friendly characteristics, the secondary battery is used in various and wide-ranging applications across industries. In particular, among secondary batteries, a lithium secondary battery is widely utilized in the industry, including portable devices that require high-density energy.

The operating principle of the lithium secondary battery is an electrochemical oxidation-reduction reaction. That is, electricity is generated by the movement of lithium ions, and the opposite process constitutes charging. In the case of a lithium secondary battery, the phenomenon in which lithium ions escape from the anode and move to the cathode through the electrolyte and separator is referred to as discharging. The reverse process of this phenomenon is referred to as charging.

If sealing of the secondary battery is not properly performed during the sealing process, problems in performance and stability of the secondary battery may occur. Therefore, research on methods of sealing secondary batteries is actively being conducted.

### SUMMARY OF THE INVENTION

The problem to be solved by the present disclosure is to provide a battery cell manufacturing apparatus and a battery cell manufacturing method for producing a battery cell with improved performance.

Another problem to be solved by the present disclosure is to provide a battery cell manufacturing apparatus and a battery cell manufacturing method for manufacturing a battery cell with improved stability of a sealing portion.

In addition, the present disclosure can be widely applied in green technology fields using batteries, such as electric vehicles, battery charging stations, solar power generation, and wind power generation.

Furthermore, the present disclosure can be used in eco-friendly electric vehicles and hybrid vehicles to prevent climate change by suppressing air pollution and greenhouse gas emissions.

As a technical means to achieve the technical objects, a battery cell manufacturing apparatus according to the present disclosure is a manufacturing apparatus for manufacturing a battery cell comprising an electrode assembly and an exterior material accommodating the electrode assembly, the battery cell manufacturing apparatus comprising: a first heating unit heating a sealing portion formed along an outside of an accommodating portion accommodating the electrode assembly such that a temperature of the sealing portion becomes a preset first temperature; a second heating unit heating the sealing portion such that the temperature of the sealing portion becomes a preset second temperature; and a control unit controlling the first heating unit and the second heating unit based on a temperature of the exterior material.

In addition, the first heating unit may heat the sealing portion in a non-contact manner.

In addition, when the first heating unit heats the sealing portion, the battery cell manufacturing apparatus may further comprise a cover unit covering the accommodating portion.

In addition, the first heating unit may heat the sealing portion by irradiating light onto the sealing portion.

In addition, the second heating unit may heat the sealing portion in a contact manner.

In addition, the second heating unit may comprise a first body and a second body with the sealing portion positioned therebetween.

In addition, the first body may press one surface of the sealing portion, and the second body may press another surface opposite to the one surface of the sealing portion.

In addition, the preset first temperature may be lower than the preset second temperature.

In addition, the preset first temperature may be equal to or higher than 90° C. and equal to or lower than 140° C.

In addition, the preset second temperature may be greater than 140° C. and equal to or lower than 220° C.

In addition, the battery cell manufacturing apparatus may further comprise a sensing unit measuring an insulation resistance of the battery cell.

In addition, the control unit may control operations of the first heating unit and the second heating unit based on the insulation resistance sensed by the sensing unit.

In addition, the battery cell manufacturing method of the present disclosure is a battery cell manufacturing method for manufacturing a battery cell comprising an electrode assembly and an exterior material accommodating the electrode assembly, the method comprising: heating a sealing portion formed along an outside of an accommodating portion accommodating the electrode assembly such that a temperature of the sealing portion becomes a preset first temperature; and heating the sealing portion such that the temperature of the sealing portion becomes a preset second temperature.

In addition, the heating the sealing portion such that the temperature of the sealing portion becomes the preset first temperature may be performed prior to the heating step of heating the sealing portion such that the temperature of the sealing portion becomes the preset second temperature.

In addition, the heating the sealing portion such that the temperature of the sealing portion becomes the preset first temperature may comprise heating the sealing portion in a non-contact manner.

In addition, the heating the sealing portion such that the temperature of the sealing portion becomes the preset second temperature may comprise heating the sealing portion in a contact manner.

In addition, the preset first temperature may be lower than the preset second temperature.

In addition, the preset first temperature may be equal to or higher than 90° C. and equal to or lower than 140° C.

In addition, the preset second temperature may be greater than 140° C. and equal to or lower than 220° C.

In addition, the method may further comprise a covering the accommodating portion accommodating the electrode assembly with a cover unit to block heat.

According to one embodiment of the present disclosure, a battery cell manufacturing apparatus and a battery cell manufacturing method for producing a battery cell with improved performance can be provided.

In addition, according to another embodiment of the present disclosure, a battery cell manufacturing apparatus and a battery cell manufacturing method for manufacturing a battery cell with improved stability of a sealing portion can be provided.

### BRIEF DESCRIPTION OF THE DRAWINGS

FIG. 1 is an exploded view of a battery cell according to an embodiment of the present disclosure.

FIG. 2 is a side view of the battery cell according to an embodiment of the present disclosure.

FIG. 3 illustrates a battery cell manufacturing apparatus according to an embodiment of the present disclosure.

FIG. 4 is a block diagram illustrating a control method of the battery cell manufacturing apparatus according to an embodiment of the present disclosure.

FIG. 5 illustrates experimental results using the battery cell manufacturing apparatus according to an embodiment of the present disclosure.

FIG. 6 illustrates a sequence of the battery cell manufacturing method according to an embodiment of the present disclosure.

### DETAILED DESCRIPTION

Hereinafter, the present disclosure will be described in detail with reference to the accompanying drawings. However, this is merely exemplary and the present disclosure is not limited to the specific embodiments described as examples.

Specific terms used in the present specification are merely for convenience of explanation and are not used as limitations of the illustrated embodiments.

For example, expressions such as “same” and “identical” not only indicate a strictly identical state but also indicate a state in which there is a tolerance or a difference to the extent that the same function can be obtained.

For example, expressions indicating relative or absolute arrangements such as “in a certain direction,” “along a certain direction,” “parallel,” “perpendicular,” “toward the center,” “concentric,” or “coaxial” not only indicate a strictly corresponding arrangement but also indicate a state in which there is a tolerance or a displacement with an angle or distance to the extent that the same function can be obtained.

In order to describe the present disclosure, the following description will be given based on a spatial orthogonal coordinate system defined by mutually orthogonal X-axis, Y-axis, and Z-axis. Each axial direction (X-axis direction, Y-axis direction, Z-axis direction) refers to both directions in which each axis extends.

The X-direction, Y-direction, and Z-direction mentioned hereinafter are for explaining the present disclosure so that it can be clearly understood, and it is of course possible that each direction may be defined differently depending on the reference point.

The use of terms with expressions such as “first,” “second,” “third,” etc. in front of components mentioned hereinafter is merely to avoid confusion of the components being referred to, and is not related to order, importance, or a primary-subordinate relationship among the components. For example, an invention including only a second component without a first component may also be implemented.

The terms used in the present disclosure are for describing particular embodiments and are not intended to limit the scope of the claims. As used in the description of the embodiments and the appended claims, the singular forms are intended to include plural forms as well, unless the context clearly indicates otherwise.

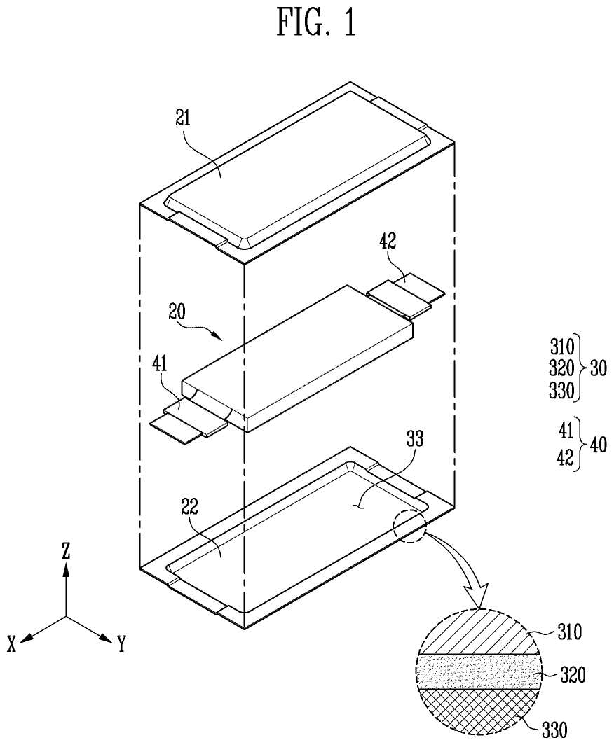

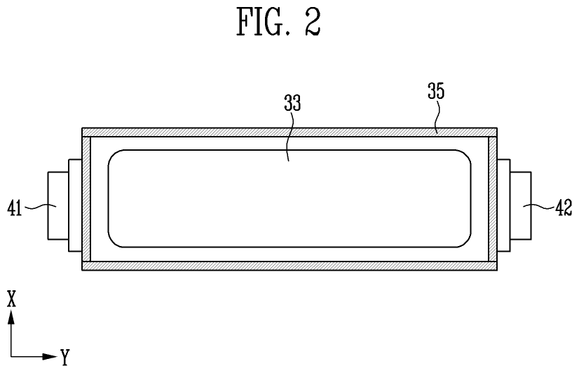

FIG. 1 is an exploded view of a battery cell according to an embodiment of the present disclosure. FIG. 2 is a side view of the battery cell according to an embodiment of the present disclosure.

The battery cell manufacturing apparatus 100 of the present disclosure can manufacture a battery cell 10 comprising an electrode assembly 20 and an exterior material 30 accommodating the electrode assembly 20. The battery cell manufacturing apparatus 100 of the present disclosure includes: a first heating unit 110 heating a sealing portion 35 formed along an outside of an accommodating portion 33 accommodating the electrode assembly 20 such that a temperature of the sealing portion 35 becomes a preset first temperature; a second heating unit 120 heating the sealing portion 35 such that a temperature of the sealing portion 35 becomes a preset second temperature; and a control unit 200 controlling the first heating unit 110 and the second heating unit 120 based on a temperature of the exterior material 30.

The battery cell 10 refers to a secondary battery that can be repeatedly used by charging and discharging electrical energy. For example, it may refer to a lithium secondary battery or a lithium-ion battery, but is not limited thereto. In another example, it may refer to an all-solid-state battery.

The battery cell 10 may be classified as a pouch-type secondary battery, a prismatic secondary battery, or a cylindrical secondary battery according to its shape. In the present specification, for convenience of explanation, a pouch-type secondary battery is illustrated as an example, but the present disclosure is not limited thereto.

The battery cell 10 may comprise an electrode assembly 20. The electrode assembly 20 may include a positive electrode and a negative electrode. The electrode assembly 20 may generate electrical energy through a redox reaction between the positive electrode and the negative electrode and supply the electrical energy to an external device. Here, the external device may be an automobile, but is not particularly limited as long as it is a device requiring electrical energy.

The battery cell 10 may further comprise an exterior material 30 accommodating the electrode assembly 20 therein. The electrode assembly 20 and an electrolyte may be accommodated inside the exterior material 30. The exterior material 30 may be formed in a multilayer structure. The exterior material 30 may be formed in a sheet shape in which layers having different properties are laminated.

In an embodiment, the exterior material 30 may comprise an outer insulating layer, an inner adhesive layer, and a metal layer 320 interposed between the outer insulating layer 330 and the inner adhesive layer.

In an embodiment, the exterior material 30 may comprise at least one of polyethylene terephthalate, nylon, aluminum, and polypropylene.

In an embodiment, the exterior material 30 may be formed by sequentially laminating polyethylene terephthalate/nylon/aluminum/polypropylene from the outside toward the inside. The inner adhesive layer 310 may comprise polypropylene. The metal layer 320 may comprise aluminum. The outer insulating layer 330 may comprise polyethylene terephthalate.

In an embodiment, the exterior material 30 may further comprise modified polypropylene. The modified polypropylene may be disposed between the aluminum and the polypropylene. The modified polypropylene may improve adhesion between the aluminum and the polypropylene.

The battery cell 10 may further comprise an electrolyte. The electrolyte may be a medium for transferring ions or current between the positive electrode and the negative electrode. The electrolyte may be a non-aqueous electrolyte solution. The electrolyte may comprise a lithium salt and an organic solvent. The electrolyte may be accommodated inside the exterior material 30 together with the electrode assembly 20.

In an embodiment, the electrolyte may comprise a lithium salt such as lithium hexafluorophosphate (LiPF₆) or lithium tetrafluoroborate (LiBF₄), and an organic solvent. The organic solvent may comprise at least one of propylene carbonate, ethylene carbonate, dimethyl carbonate, ethyl methyl carbonate, and diethyl carbonate.

The battery cell 10 may further comprise a tab portion 40. The tab portion 40 may protrude to the outside of the exterior material 30. The tab portion 40 may electrically connect the electrode assembly 20 to an external device. One end of the tab portion 40 may be located inside the exterior material 30, and the other end may be located outside the exterior material 30. The tab portion 40 may be connected to the positive electrode and the negative electrode, respectively. The tab portion 40 may comprise a positive electrode tab 41 connected to the positive electrode and a negative electrode tab 42 connected to the negative electrode.

Referring to FIG. 1, the exterior material 30 may comprise a first housing 21 and a second housing 22. The first housing 21 and the second housing 22 may each comprise an inner adhesive layer 310, a metal layer 320, and an outer insulating layer 330.

An accommodating portion 33 for accommodating the electrode assembly 20 may be formed in at least one of the first housing 21 and the second housing 22. The first housing 21 and the second housing 22 may be connected to each other to cover the accommodating portion 33.

The first housing 21 and the second housing 22 may be sealed such that respective edges thereof abut against each other. When the first housing 21 and the second housing 22 are sealed, the accommodating portion 33 may be formed to be surrounded by the sealing portion 35, thereby having a predetermined volume.

The sealing portion 35 may be formed along respective edges of the first housing 21 and the second housing 22. By sealing the sealing portion 35, the accommodating portion 33 may be hermetically maintained. In other words, after the sealing portion 35 is sealed, the electrode assembly 20 and the electrolyte in the accommodating portion 33 may not leak to the outside of the exterior material 30.

In an embodiment, the first housing 21 and the second housing 22 may be integrally formed. After folding the first housing 21 and the second housing 22, the sealing portion 35 may be formed along edges of the first housing 21 and the second housing 22.

Referring to FIG. 1, the tab portion 40 may be positioned between the first housing 21 and the second housing 22. When the exterior material 30 is sealed, one surface of the tab portion 40 may contact the first housing 21, and the other surface of the tab portion 40 may contact the second housing 22.

Referring to FIG. 2, the positive electrode tab 41 and the negative electrode tab 42 may protrude in different directions. The positive electrode tab 41 may protrude in the −Y-axis direction, and the negative electrode tab 42 may protrude in the +Y-axis direction. The positive electrode tab 41 and the negative electrode tab 42 may also protrude in the same direction.

The sealing portion 35 may be formed along an edge of the accommodating portion 33. Ultimately, when the edges of the first housing 21 and the second housing 22 are sealed to abut against each other, the accommodating portion 33 may be formed at the center and the sealing portion 35 may be formed at the outside.

Referring to FIG. 2, the sealing portion 35 may be formed on one surface of the exterior material 30 from which the tab portion 40 protrudes. In addition, the sealing portion 35 may also be formed on one surface of the exterior material 30 from which the tab portion 40 does not protrude. In other words, the sealing portion 35 may be formed in a direction parallel to the direction in which the tab portion 40 protrudes from one surface of the exterior material 30. The position of the sealing portion 35 is not limited as long as the accommodating portion 33 can be hermetically maintained.

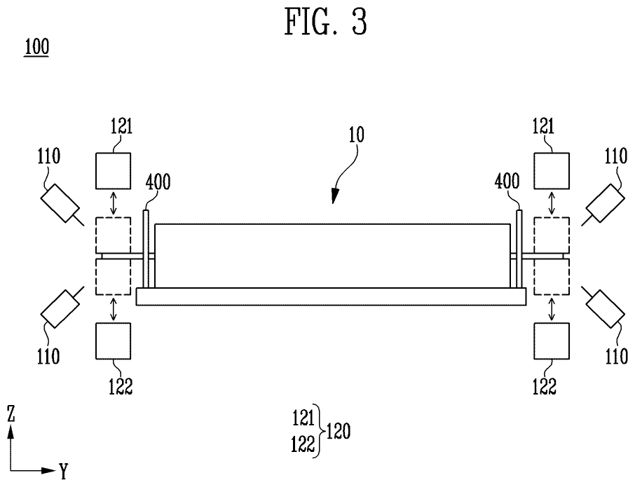

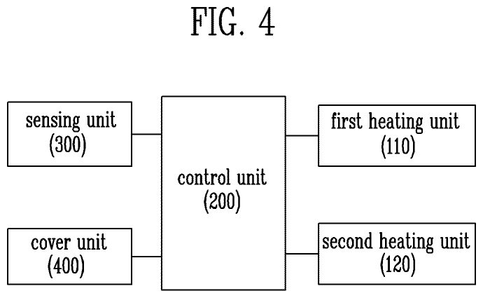

FIG. 3 illustrates a battery cell manufacturing apparatus according to an embodiment of the present disclosure. FIG. 4 is a block diagram illustrating a control method of the battery cell manufacturing apparatus according to an embodiment of the present disclosure.

The battery cell manufacturing apparatus 100 of the present disclosure may heat the sealing portion 35 through the first heating unit 110 and the second heating unit 120. The heated sealing portion 35 may be melted and then bonded. That is, after the first housing 21 and the second housing 22 are respectively melted, they may be bonded to each other.

The first heating unit 110 heats the sealing portion 35 such that a temperature of the sealing portion 35 becomes a preset first temperature, and the second heating unit 120 heats the sealing portion 35 such that a temperature of the sealing portion 35 becomes a preset second temperature, whereby even if some components are melted, the remaining components may not be melted.

Here, some components and the remaining components may refer to the electrolyte and the exterior material 30. More specifically, when the exterior material 30 is formed in a multilayer structure, even if one of the layers is melted, another layer may not be melted.

The present disclosure may further comprise a sensing unit 300 measuring an insulation resistance of the battery cell 10. When sealing of the exterior material 30 is determined to be defective in the manufacturing process of the battery cell 10, a resealing process for resealing the defective portion may be performed. After measuring the insulation resistance of the battery cell 10, it may be determined whether the sealing is defective based on the measured insulation resistance value.

The sensing unit 300 may be a probe. The sensing unit 300 may be connected to the exterior material 30 and the tab portion 40, respectively. In an embodiment, the probe may be connected to the exterior material 30 and the negative electrode tab 42, respectively. Through this, it may be confirmed whether insulation is present between the negative electrode tab 42 and the exterior material 30.

When the first housing 21 and the second housing 22 are sealed while abutting against each other, respective inner adhesive layers 310 may be in contact with each other.

If the inner adhesive layer 310 is damaged due to external impact or vibration, the electrolyte may contact the metal layer 320 (for example, an aluminum layer) located outside the inner adhesive layer 310. When the electrolyte contacts the metal layer 320, insulation may be broken.

When the sealing portion 35 is heated while the electrolyte is located between the metal layers 320, the electrolyte and the inner adhesive layer 310 may be heated. In this case, the inner adhesive layer 310 may be further damaged by the electrolyte, and the problem of insulation breakdown may not be resolved. Therefore, the problem of insulation breakdown can be resolved only when the electrolyte located between the metal layers 320 is removed and then the inner adhesive layer 310 is melted.

The battery cell manufacturing apparatus 100 of the present disclosure may reseal the exterior material 30 after vaporizing the electrolyte when the sealing portion 35 is defective.

The temperature of the sealing portion 35 may reach a preset first temperature by the first heating unit 110. The temperature of the sealing portion 35 may rise from a temperature lower than the preset first temperature to the preset first temperature.

In an embodiment, the first heating unit 110 may heat the sealing portion 35 in a non-contact manner. Since the sealing portion 35 is heated in a non-contact manner, damage to the appearance of the sealing portion 35 may not occur. In addition, the electrolyte located between the inner adhesive layer 310 of the first housing 21 and the inner adhesive layer 310 of the second housing 22 may be vaporized.

The first heating unit 110 may heat the sealing portion 35 by irradiating light onto the sealing portion 35. The light irradiated from the first heating unit 110 may have various wavelengths. For example, the first heating unit 110 may irradiate infrared rays to heat the sealing portion 35. Through the infrared rays, the temperature of the sealing portion 35 may reach the preset first temperature in a relatively short time. In an embodiment, the first heating unit 110 may use a halogen lamp, an LED lamp, or a diode lamp.

The temperature of the sealing portion 35 may reach a preset second temperature by the second heating unit 120. The temperature of the sealing portion 35 may rise from a temperature lower than the preset second temperature to the preset second temperature.

The second heating unit 120 may heat the sealing portion 35 in a contact manner. The second heating unit 120 may contact at least one of the first housing 21 and the second housing 22. The second heating unit 120 may heat the sealing portion 35 while pressing it.

The second heating unit 120 may comprise a first body 121 and a second body 122 with the sealing portion 35 positioned therebetween. The sealing portion 35 may be positioned between the first body 121 and the second body 122. The sealing portion 35 may be pressed by the first body 121 and the second body 122.

The first body 121 may press one surface of the sealing portion 35, and the second body 122 may press another surface of the sealing portion 35. In an embodiment, the first body 121 may contact the first housing 21, and the second body 122 may contact the second housing 22.

Referring to FIG. 3, the second heating unit 120 may change its position to press the sealing portion 35. The first body 121 and the second body 122 may move toward each other to press the sealing portion 35. At this time, since the first body 121 and the second body 122 have a preset temperature, the temperature of the sealing portion 35 may be raised to the preset second temperature through contact with the sealing portion 35.

Here, the preset temperatures of the first body 121 and the second body 122 may be the same. The preset temperature may vary based on a relationship with the time during which the second heating unit 120 contacts the sealing portion 35. In other words, in order to heat the sealing portion 35 to the preset second temperature, the temperature of the second heating unit 120 may vary. In addition, the contact time between the second heating unit 120 and the sealing portion 35 may also be adjusted.

The preset first temperature may be lower than the preset second temperature. The preset first temperature may be equal to or higher than 90° C. and equal to or lower than 140° C. The preset second temperature may be greater than 140° C. and equal to or lower than 220° C.

Since the preset first temperature is lower than the preset second temperature, the sealing portion 35 may be melted after the electrolyte is removed. In other words, when the sealing portion 35 reaches the preset first temperature, the electrolyte located between the inner adhesive layer 310 of the first housing 21 and the inner adhesive layer 310 of the second housing 22 may be removed. When the first heating unit 110 heats the sealing portion 35 in a non-contact manner, heat may be efficiently transferred to the electrolyte as compared with the case of heating the sealing portion 35 in a contact manner.

Meanwhile, the battery cell 10 of the present disclosure may further comprise a cover unit 400 covering the accommodating portion 33 when the first heating unit 110 heats the sealing portion 35. The accommodating portion 33 may prevent heat from being transferred to the electrode assembly 20. This is to prevent defects caused by a temperature rise of the electrode assembly 20.

Referring to FIG. 3, the cover unit 400 may be positioned between the first heating unit 110 and the accommodating portion 33 when the first heating unit 110 heats the sealing portion 35. The cover unit 400 may be formed of a heat-insulating material.

The control unit 200 may control the first heating unit 110 and the second heating unit 120 based on a temperature of the exterior material 30. The control unit 200 may stop an operation of the first heating unit 110 when the temperature of the sealing portion 35 reaches the preset first temperature. In addition, the control unit 200 may stop an operation of the second heating unit 120 when the temperature of the sealing portion 35 reaches the preset second temperature.

The control unit 200 may control operations of the first heating unit 110 and the second heating unit 120 based on the insulation resistance sensed by the sensing unit 300. The control unit 200 may determine whether the sealing portion 35 is defective based on the insulation resistance. When the control unit 200 determines the sealing portion 35 to be defective, it may control the first heating unit 110 and the second heating unit 120 to heat the sealing portion 35.

Referring to FIG. 4, the control unit 200 may control the cover unit 400. When the first heating unit 110 heats the sealing portion 35, the control unit 200 may control the cover unit 400 to move between the accommodating portion 33 and the first heating unit 110.

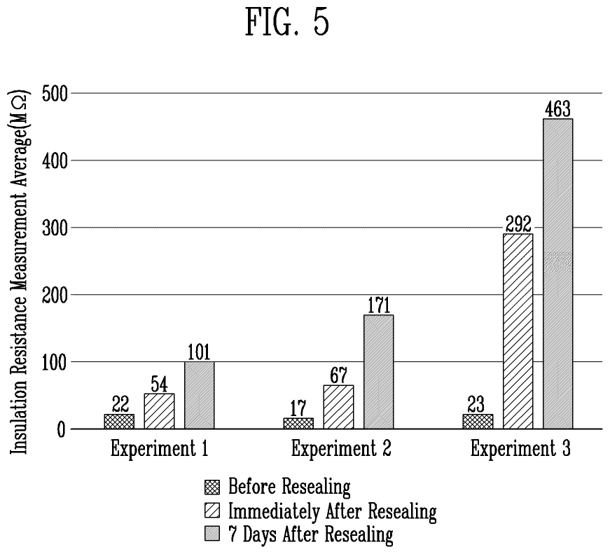

FIG. 5 illustrates experimental results using the battery cell manufacturing apparatus according to an embodiment of the present disclosure. Specifically, it illustrates results of measuring insulation resistance after resealing the sealing portion 35 of the exterior material 30.

In Experiment 1, sealing was performed using a sealing bar. The temperature of the sealing bar was set to 190° C., and the sealing portion 35 was heated for about 5 seconds. Experiments 2 and 3 are results of performing sealing using a halogen lamp in addition to the sealing bar.

In Experiment 2, the temperature of the halogen lamp was set to 100° C., and the sealing portion 35 was heated for about 5 seconds. Thereafter, the temperature of the sealing bar was set to 190° C., and the sealing portion 35 was heated for about 5 seconds.

In Experiment 3, the temperature of the halogen lamp was set to 140° C., and the sealing portion 35 was heated for about 15 seconds. Thereafter, the temperature of the sealing bar was set to 190° C., and the sealing portion 35 was heated for about 5 seconds.

Referring to FIG. 5, it can be confirmed that the insulation resistance values improved after resealing in Experiments 2 and 3. In addition, it can be confirmed that the insulation resistance values of Experiments 2 and 3 were remarkably higher than that of Experiment 1 after 7 days from resealing.

Accordingly, the battery cell manufacturing apparatus 100 of the present disclosure can manufacture a battery cell 10 with improved sealing performance by sequentially performing sealing through the first heating unit 110 and the second heating unit 120.

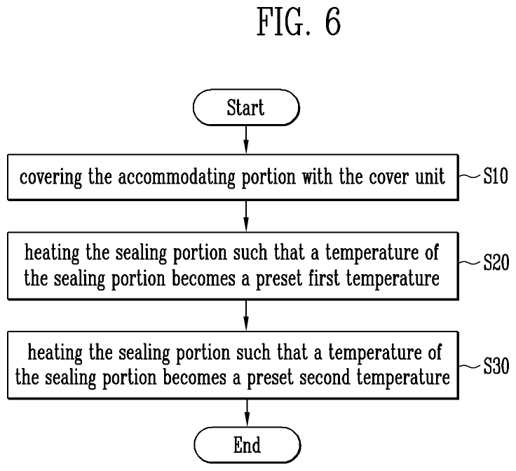

FIG. 6 illustrates a sequence of the battery cell manufacturing method according to an embodiment of the present disclosure.

The battery cell 10 manufacturing method of the present disclosure comprises: a step S20 of heating the sealing portion 35 formed along an outside of the accommodating portion 33 accommodating the electrode assembly 20 such that a temperature of the sealing portion 35 becomes a preset first temperature; and a step S30 of heating the sealing portion 35 such that a temperature of the sealing portion 35 becomes a preset second temperature.

Referring to FIG. 6, in the battery cell 10 manufacturing method of the present disclosure, the step S20 of heating the sealing portion 35 such that the temperature of the sealing portion 35 becomes the preset first temperature may be performed prior to the step S30 of heating the sealing portion 35 such that the temperature of the sealing portion 35 becomes the preset second temperature. Here, the preset first temperature may be lower than the preset second temperature.

The preset first temperature may be equal to or higher than 90° C. and equal to or lower than 140° C., and the preset second temperature may be greater than 140° C. and equal to or lower than 220° C. Through this, after removing the electrolyte, the sealing portion 35 may be melted and fused.

In the battery cell 10 manufacturing method of the present disclosure, in the step S20 of heating the sealing portion 35 such that the temperature of the sealing portion 35 becomes the preset first temperature, the sealing portion 35 may be heated in a non-contact manner. In an embodiment, the first heating unit 110 may heat the sealing portion 35 in a non-contact manner.

In addition, in the battery cell 10 manufacturing method of the present disclosure, in the step S30 of heating the sealing portion 35 such that the temperature of the sealing portion 35 becomes the preset second temperature, the sealing portion 35 may be heated in a contact manner. In an embodiment, the second heating unit 120 may heat the sealing portion 35 by contacting the sealing portion 35.

Meanwhile, the battery cell 10 manufacturing method of the present disclosure may further comprise a step S10 of covering the accommodating portion 33 accommodating the electrode assembly 20 with a cover unit 400 to block heat. The battery cell 10 manufacturing method of the present disclosure may perform the step S10 of covering the accommodating portion 33 prior to the step S20 of heating the sealing portion 35 such that the temperature of the sealing portion 35 becomes the preset first temperature.

The present disclosure may be embodied in various forms, and the scope of rights is not limited to the above-described embodiments. The above description is merely an example applying the principles of the present disclosure, and other configurations may be further included within a scope not departing from the scope of the present invention.

What is claimed is:

1. A battery cell manufacturing apparatus for manufacturing a battery cell comprising an electrode assembly and an exterior material accommodating the electrode assembly, the battery cell manufacturing apparatus comprising:
a first heating unit heating a sealing portion formed along an outside of an accommodating portion accommodating the electrode assembly such that a temperature of the sealing portion becomes a preset first temperature;
a second heating unit heating the sealing portion such that the temperature of the sealing portion becomes a preset second temperature; and
a control unit controlling the first heating unit and the second heating unit based on a temperature of the exterior material.

2. The battery cell manufacturing apparatus according to claim 1, further comprising:
a cover unit covering the accommodating portion when the first heating unit heats the sealing portion.

3. The battery cell manufacturing apparatus according to claim 1, wherein the first heating unit heats the sealing portion in a non-contact manner.

4. The battery cell manufacturing apparatus according to claim 2, wherein the first heating unit heats the sealing portion by irradiating light onto the sealing portion.

5. The battery cell manufacturing apparatus according to claim 2, wherein the second heating unit heats the sealing portion in a contact manner.

6. The battery cell manufacturing apparatus according to claim 5, wherein the second heating unit comprises a first body and a second body with the sealing portion positioned therebetween.

7. The battery cell manufacturing apparatus according to claim 6, wherein the first body presses one surface of the sealing portion, and the second body presses another surface opposite to the one surface of the sealing portion.

8. The battery cell manufacturing apparatus according to claim 5, wherein the preset first temperature is lower than the preset second temperature.

9. The battery cell manufacturing apparatus according to claim 8, wherein the preset first temperature is equal to or higher than 90° C. and equal to or lower than 140°C.

10. The battery cell manufacturing apparatus according to claim 8, wherein the preset second temperature is greater than 140° C. and equal to or lower than 220°C.

11. The battery cell manufacturing apparatus according to claim 1, further comprising:
a sensing unit measuring an insulation resistance of the battery cell.

12. The battery cell manufacturing apparatus according to claim 11, wherein the control unit controls operations of the first heating unit and the second heating unit based on the insulation resistance sensed by the sensing unit.

13. A battery cell manufacturing method for manufacturing a battery cell comprising an electrode assembly and an exterior material accommodating the electrode assembly, the battery cell manufacturing method comprising:
heating a sealing portion formed along an outside of an accommodating portion accommodating the electrode assembly such that a temperature of the sealing portion becomes a preset first temperature; and
heating the sealing portion such that the temperature of the sealing portion becomes a preset second temperature.

14. The battery cell manufacturing method according to claim 13, wherein the heating the sealing portion such that the temperature of the sealing portion becomes the preset first temperature is performed prior to the heating step of heating the sealing portion such that the temperature of the sealing portion becomes the preset second temperature.

15. The battery cell manufacturing method according to claim 14, wherein the heating the sealing portion such that the temperature of the sealing portion becomes the preset first temperature comprises heating the sealing portion in a non-contact manner.

16. The battery cell manufacturing method according to claim 15, wherein the heating the sealing portion such that the temperature of the sealing portion becomes the preset second temperature comprises heating the sealing portion in a contact manner.

17. The battery cell manufacturing method according to claim 13, wherein the preset first temperature is lower than the preset second temperature.

18. The battery cell manufacturing method according to claim 17, wherein the preset first temperature is equal to or higher than 90° C. and equal to or lower than 140° C.

19. The battery cell manufacturing method according to claim 17, wherein the preset second temperature is greater than 140° C. and equal to or lower than 220° C.

20. The battery cell manufacturing method according to claim 13, further comprising:
covering the accommodating portion accommodating the electrode assembly with a cover unit to block heat.
